(19) United States
(12) Patent Application Publication
(10) Pub. No.: US 2020/0053394 A1
(43) Pub. Date: Feb. 13, 2020

(54) CONTENT PROCESSING APPARATUS, CONTENT PROCESSING METHOD, AND PROGRAM

(71) Applicant: SONY CORPORATION, Tokyo (JP)

(72) Inventors: Tomizo SHIRAISHI, Kanagawa (JP); Kazuhiko TAKABAYASHI, Tokyo (JP); Mitsuhiro HIRABAYASHI, Tokyo (JP)

(73) Assignee: SONY CORPORATION, Tokyo (JP)

(21) Appl. No.: 16/486,044

(22) PCT Filed: Mar. 14, 2018
(86) PCT No.: PCT/JP2018/009914

§ 371 Date: Aug. 14, 2019

(30) Foreign Application Priority Data
Mar. 24, 2017 (JP) 2017-060222

(51) Int. Cl. H04N 21/2187; H04N 21/236; H04N 21/2343; H04N 21/643; H04N 21/254; H04N 21/2662; G11B 27/02

(52) U.S. Cl. CPC H04N 21/2187; H04N 21/236; H04N 21/2343; G11B 27/02; H04N 21/2541; H04N 21/2662; H04N 21/643

(57) ABSTRACT

The present disclosure relates to a content processing apparatus, a content processing method, and a program that are capable of suitably editing content to be distributed. An online editing unit stores content data for live distribution in an editing buffer, corrects, if the content data includes a problem part, the content data within the editing buffer, replaces the content data with the corrected content data, and distributes the corrected content data. An offline editing unit reads the content data from a saving unit and edits the content data on a plurality of editing levels. The present technology is applicable to, for example, a distribution system that distributes content by MPEG-DASH.

### TECHNICAL FIELD

The present disclosure relates to a content processing apparatus, a content processing method, and a program, and more particularly to a content processing apparatus, a content processing method, and a program that are capable of suitably editing content to be distributed.

### BACKGROUND ART

In the course of the standardization of Internet streaming such as internet protocol television (IPTV), a method applied to video on demand (VOD) streaming by hypertext transfer protocol (HTTP) streaming or live streaming has been standardized.

In particular, MPEG-DASH (Moving Picture Experts Group Dynamic Adaptive Streaming over HTTP) that is standardized in ISO/IEC/MPEG is attracting attention (see, e.g., Non-Patent Literature 1).

By the way, conventionally, after events of music concerts, sports, and the like are distributed by live streaming using the MPEG DASH, the same video data is distributed on demand. At that time, in the on-demand distribution, a part of the data for live distribution is replaced in some cases due to intentions of cast members, hosts, or the like.

For example, there is a case where live broadcasting of a performance of a musical artist or the like is performed and will be sold later as package media such as a DVD and a Blu-ray Disc. However, even in such a case, the broadcasting and the content production for package media are separately performed in most cases, and the broadcast video and sound are not sold as they are as package media. This is because the package media itself is an artist's work, and thus there is a growing demand for quality, so various types of editing or processing need to be performed thereon apart from using the live-recorded video and sound as they are.

Meanwhile, recently, live distribution has been performed by using DASH streaming via the Internet or the like, and the same content has been distributed on demand after the lapse of a certain period of time from the start of streaming or after the end of streaming. Note that the content may be not only content live-recorded in actuality or captured, but also content obtained by DASH-segmentalizing a feed from a broadcast station or the like in real time.

For example, there are a catch-up viewing service for users who missed the live (real-time) distribution, a service corresponding to recording on the cloud, and the like. For example, the latter case is generally referred to as a network personal video recorder (nPVR) in some cases.

In the same manner, it is assumed that a performance of a musical artist is also live-distributed by DASH streaming and is distributed on demand as needed. However, there is a case where the artist does not give permission to use the live-distributed content as it is as content viewable for a long period of time, the content corresponding to the package media described above. In such a case, the live-distributed content and the package media are produced as different content items as in the conventional live broadcasting and package media. The data that is disposed in a distribution server for live distribution and then distributed in a content delivery network (CDN) becomes unnecessary data after a live distribution period has passed, and now different data for on-demand distribution has to be disposed in the server and circulated in the CDN.

In actuality, the details (video, sound) of the live-distributed content and the content for on-demand distribution are not different in all the time and must include overlapping details (video, sound). However, the upload to the distribution server and the delivery to a cache of the CDN are performed for the overlap portion, and communication costs therefor are generated.

Further, it takes reasonable time to perform editing, adjustment, and processing for completing a final work for on-demand distribution (on level to be sold as package media), and the time interval between the end of the live distribution and the providing by on-demand distribution becomes long.

### CITATION LIST

### Patent Literature

Non-Patent Literature 1: ISO/IEC 23009-1: 2012 Information technology Dynamic adaptive streaming over HTTP (DASH)
Non-Patent Literature 2: FDIS ISO/IEC 23009-5: 201x Server and Network Assisted DASH (SAND)

### DISCLOSURE OF INVENTION

### Technical Problem

As described above, conventionally, it has taken time to edit content, and thus there is a demand to suitably edit content to be distributed.

The present disclosure has been made in view of the circumstances as described above and is capable of suitably editing content to be distributed.

### Solution to Problem

A content processing apparatus according to one aspect of the present disclosure includes an online editing unit that stores content data for live distribution in an editing buffer, corrects, if the content data includes a problem part, the content data within the editing buffer, replaces the content data with the corrected content data, and distributes the corrected content data.

A content processing method or a program according to one aspect of the present disclosure includes the steps of: storing content data for live distribution in an editing buffer; correcting, if the content data includes a problem part, the content data within the editing buffer; replacing the content data with the corrected content data; and distributing the corrected content data.

In one aspect of the present disclosure, content data for live distribution is stored in an editing buffer, the content data is corrected within the editing buffer if the content data includes a problem part, the content data is replaced with the corrected content data, and the corrected content data is distributed.

### Advantageous Effects of Invention

According to one aspect of the present disclosure, it is possible to suitably edit content to be distributed.

### BRIEF DESCRIPTION OF DRAWINGS

FIG. 1 is a block diagram showing a configuration example of one embodiment of a content distribution system to which the present technology is applied.

FIG. 2 is a diagram for describing processing from generation of live distribution data to upload to a DASH distribution server.

FIG. 3 is a diagram for describing replacement in units of segment.

FIG. 4 is a diagram for describing processing of performing offline editing.

FIG. 5 is a diagram showing an example of an MPD at live distribution.

FIG. 6 is a diagram showing an example of the MPD in which information of a segment to be replaced is added to the MPD at live distribution.

FIG. 7 is a diagram showing an example of the MPD.

FIG. 8 is a diagram showing an example of an MPD in which segments are replaced.

FIG. 9 is a diagram showing an example of a Segment Timeline element.

FIG. 10 is a diagram showing an example of Altered Segment Timeline.

FIG. 11 is a diagram showing an example of Segment Timeline.

FIG. 12 is a diagram for describing a concept of a replacement notification SAND message.

FIG. 13 is a diagram showing an example of a SAND message.

FIG. 14 is a diagram showing a definition example of a ResourceStatus element.

FIG. 15 is a diagram for describing video automatic processing and audio automatic processing.

FIG. 16 is a diagram for describing correction levels.

FIG. 17 is a block diagram showing a configuration example of a DASH client unit.

FIG. 18 is a flowchart for describing live distribution processing.

FIG. 19 is a flowchart for describing the video automatic processing.

FIG. 20 is a flowchart for describing the audio automatic processing.

FIG. 21 is a flowchart for describing DASH client processing.

FIG. 22 is a flowchart for describing offline editing processing.

FIG. 23 is a flowchart for describing replacement data generation processing.

FIG. 24 is a block diagram showing a configuration example of one embodiment of a computer to which the present technology is applied.

### MODE(S) FOR CARRYING OUT THE INVENTION

Hereinafter, a specific embodiment to which the present technology is applied will be described in detail with reference to the drawings.

<Configuration Example of Content Distribution System>

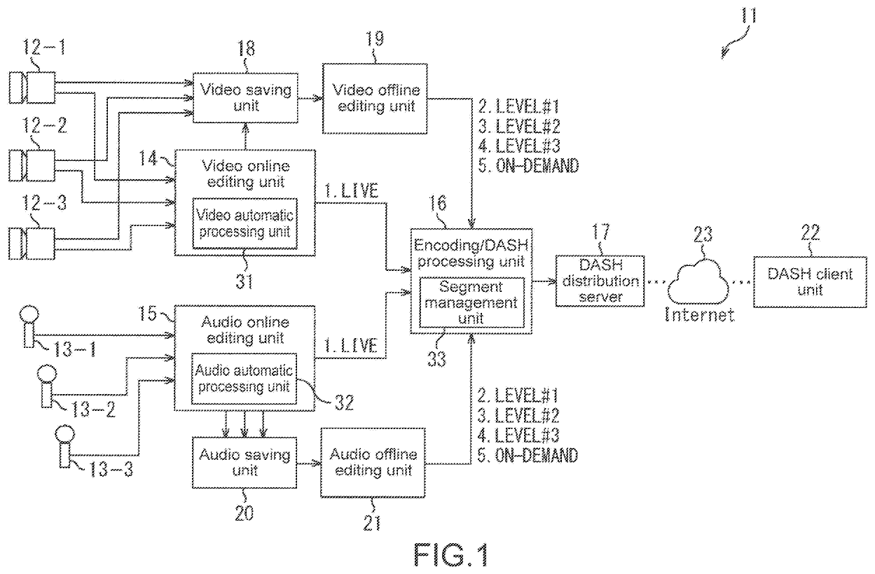

FIG. 1 is a block diagram showing a configuration example of one embodiment of a content distribution system to which the present technology is applied.

As shown in FIG. 1, a content distribution system 11 includes imaging apparatuses 12-1 to 12-3, sound collection apparatuses 13-1 to 13-3, a video online editing unit 14, an audio online editing unit 15, an encoding/DASH processing unit 16, a DASH distribution server 17, a video saving unit 18, a video offline editing unit 19, an audio saving unit 20, an audio offline editing unit 21, and a DASH client unit 22. Further, in the content distribution system 11, the DASH distribution server 17 and the DASH client unit 22 are connected to each other via a network 23 such as the Internet.

For example, when live distribution (broadcasting) is performed in the content distribution system 11, a plurality of imaging apparatuses 12 and a plurality of sound collection apparatuses 13 (three each in the example of FIG. 1) are used to image a live situation and to collect sounds thereof from various directions.

Each of the imaging apparatuses 12-1 to 12-3 includes, for example, a digital video camera capable of capturing a video. The imaging apparatuses 12-1 to 12-3 capture respective live videos and supply those videos to the video online editing unit 14 and the video saving unit 18.

Each of the sound collection apparatuses 13-1 to 13-3 includes, for example, a microphone capable of collecting sounds. The sound collection apparatuses 13-1 to 13-3 collect respective live sounds and supply those sounds to the audio online editing unit 15.

The video online editing unit 14 performs selection or mixing with a switcher or a mixer on the videos supplied from the respective imaging apparatuses 12-1 to 12-3 and further adds various effects or the like thereto. Further, the video online editing unit 14 includes a video automatic processing unit 31 and can correct, by the video automatic processing unit 31, RAW data obtained after the imaging apparatuses 12-1 to 12-3 perform imaging. The video online editing unit 14 then applies such editing to generate a video stream for distribution, and outputs the video stream for distribution to the encoding/DASH processing unit 16 and also supplies the video stream for distribution to the video saving unit 18 to cause the video saving unit 18 to save it.

The audio online editing unit 15 performs selection or mixing with a switcher or a mixer on the sounds supplied from the respective sound collection apparatuses 13-1 to 13-3 and further adds various effects or the like thereto. Further, the audio online editing unit 15 includes an audio automatic processing unit 32 and can correct, by the audio automatic processing unit 32, sound data obtained after the sound collection apparatuses 13-1 to 13-3 collect sounds. The audio online editing unit 15 then applies such editing to generate a sound stream for distribution, and outputs the sound stream for distribution to the encoding/DASH processing unit 16 and also supplies the sound stream for distribution to the audio saving unit 20 to cause the audio saving unit 20 to save it.

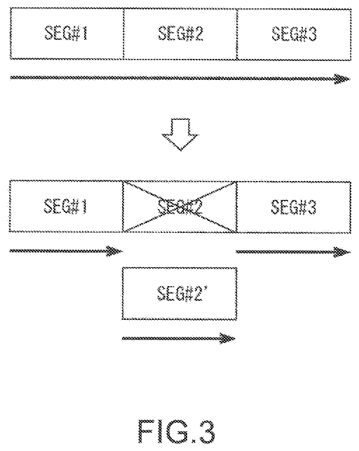

The encoding/DASH processing unit 16 encodes the video stream for distribution output from the video online editing unit 14 and the sound stream for distribution output from the audio online editing unit 15, at a plurality of bit rates as necessary. Accordingly, the encoding/DASH processing unit 16 performs DASH media segmentalization on the video stream for distribution and the sound stream for distribution and uploads the video stream and the sound stream to the DASH distribution server 17 as needed. At that time, the encoding/DASH processing unit 16 generates media presentation description (MPD) data as control information used for controlling the distribution of videos and sounds. Further, the encoding/DASH processing unit 16 includes a segment management unit 33. The segment management unit 33 can monitor the lack of data or the like, and if there is a problem, can reflect it to the MPD or replace data in units of segment as will be described later with reference to FIG. 3.

Segment data and MPD data are uploaded to the DASH distribution server 17, and the DASH distribution server 17 performs HTTP communication with the DASH client unit 22 via the network 23.

The video saving unit 18 saves the video stream for distribution for the purpose of later editing and production. Further, the original stream for live distribution is simultaneously saved in the video saving unit 18. Additionally, information of the video selected and used as a stream for live distribution (camera number or the like) is also recorded in the video saving unit 18.

The video offline editing unit 19 produces a stream for on-demand distribution on the basis of the stream for live distribution saved in the video saving unit 18. The editing details performed by the video offline editing unit 19 include, for example, replacing part of the data with a video of a camera captured from an angle different from that at the live distribution, synthesizing videos from a plurality of cameras, and performing additional effect processing at camera (video) switching.

The audio saving unit 20 saves the sound stream for distribution.

The audio offline editing unit 21 edits the sound stream for distribution saved in the audio saving unit 20. For example, the editing details performed by the audio offline editing unit 21 include replacing a part of sound disturbance with one separately recorded, adding a sound that did not exist in a live performance, and adding effect processing.

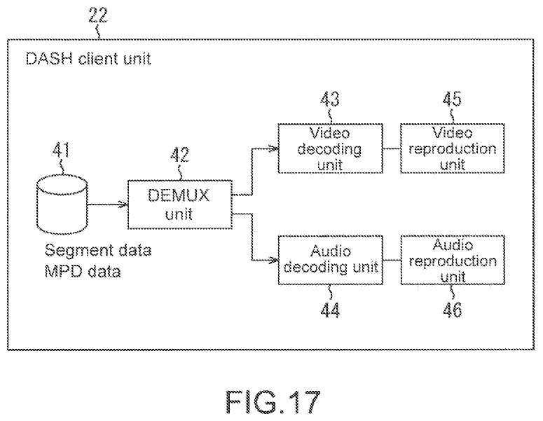

The DASH client unit 22 decodes and reproduces DASH content distributed from the DASH distribution server 17 via the network 23, and causes a user of the DASH client unit 22 to view it. Note that a specific configuration of the DASH client unit 22 will be described with reference to FIG. 17.

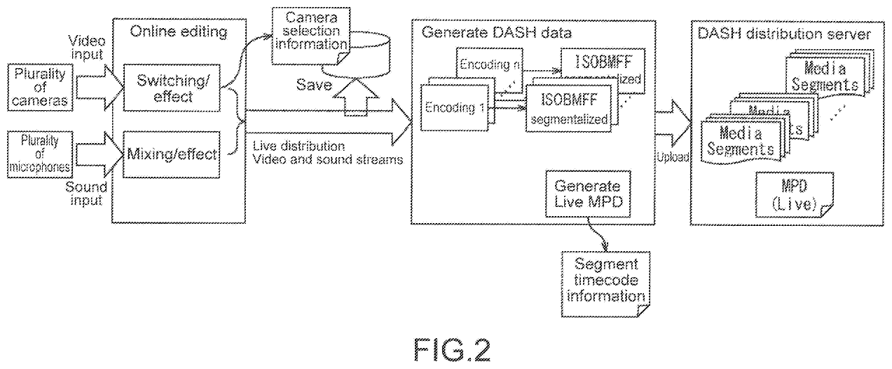

The processing from the generation of live distribution data to the upload to the DASH distribution server 17 will be described with reference to FIG. 2.

For example, the videos are input to the video online editing unit 14 from the plurality of imaging apparatuses 12, and the sounds are input to the audio online editing unit 15 from the plurality of sound collection apparatuses 13. Those videos and sounds are subjected to processing such as switching or effect processing and are output as video and sound streams for live distribution. The video and sound streams are supplied to the encoding/DASH processing unit 16 and also saved in the video saving unit 18 and the audio saving unit 20. Further, camera selection information is also saved in the video saving unit 18.

The encoding/DASH processing unit 16 encodes the video and sound streams to generate DASH data, and performs ISOBMFF segmentalization for each of segments to upload the resultant data to the DASH distribution server 17. Further, the encoding/DASH processing unit 16 generates a live MPD and outputs it as segment time code information. The DASH distribution server 17 then controls distribution for each of segments according to the live MPD.

At that time, the encoding/DASH processing unit 16 can refer to a segment file converted into DASH segments, and if there is a problem part, rewrite the MPD, to replace the encoded data in units of segment.

For example, as shown in FIG. 3, a segment #1, a segment #2, and a segment #3 are live-distributed. In a case where an accident occurs in the segment #2, that segment #2 is replaced with another segment #2′.

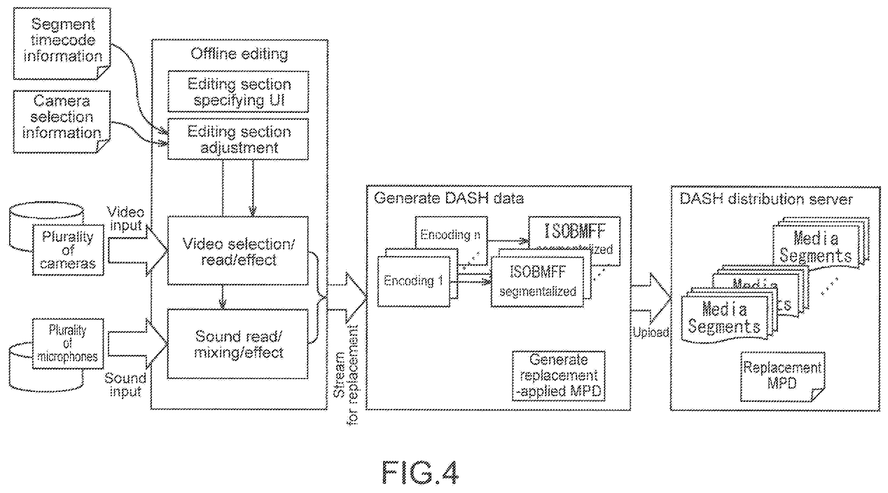

Processing of performing offline editing will be described with reference to FIG. 4.

For example, a media segment for replacement of a part to which editing/adjustment is added can be generated from the stream for live distribution, and DASH stream/data for on-demand distribution can be formed. Note that the offline editing may be performed a plurality of times after the live distribution because of the degree of urgency, importance, improvement in content additional value, or the like. For example, it may be possible to stepwisely edit, by offline editing, each part of the video and sound streams and edit the video and sound streams on a higher editing level in accordance with lapse of time after the live distribution.

For example, the videos captured by the plurality of imaging apparatuses 12 are read from the video saving unit 18 to the video offline editing unit 19, and the sounds collected by the plurality of sound collection apparatuses 13 are read from the audio saving unit 20 to the audio offline editing unit 21. In the video offline editing unit 19 and the audio offline editing unit 21, an editing section is then specified by using an editing section specifying user interface (UI), and is adjusted with reference to the segment time code information and the camera selection information. The videos and sounds subjected to such editing are then output as a stream for replacement.

The encoding/DASH processing unit 16 encodes the stream for replacement to generate DASH data, rewrites the MPD to generate a replacement-applied MPD, and uploads the replacement-applied MPD to the DASH distribution server 17. In the DASH distribution server 17, replacement is then performed for each of the segments according to the MPD for replacement, and the distribution is controlled. For example, when the video offline editing unit 19 and the audio offline editing unit 21 perform editing, the encoding/DASH processing unit 16 sequentially replaces each of the segments with the edited parts. Accordingly, the DASH distribution server 17 can perform distribution while sequentially performing replacement with the edited parts.

<Replacement of Segment by MPD>

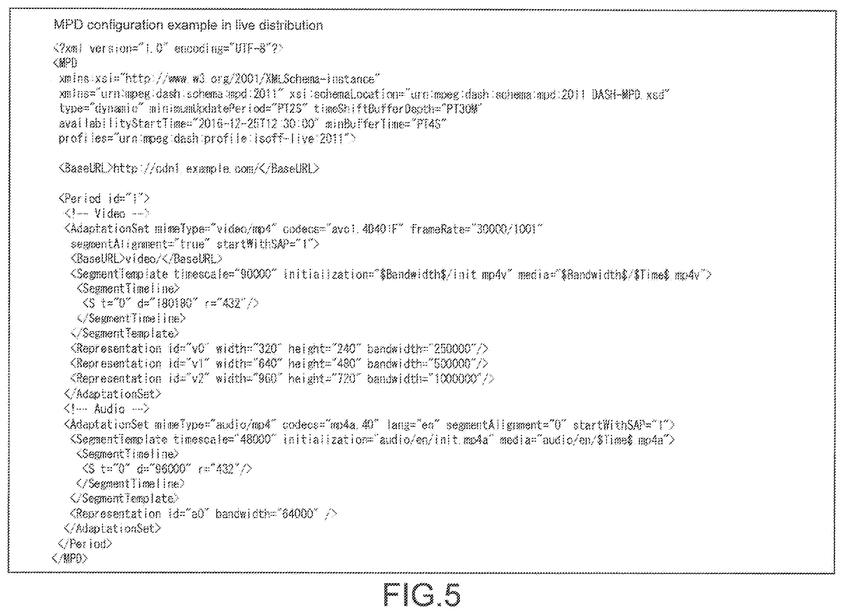

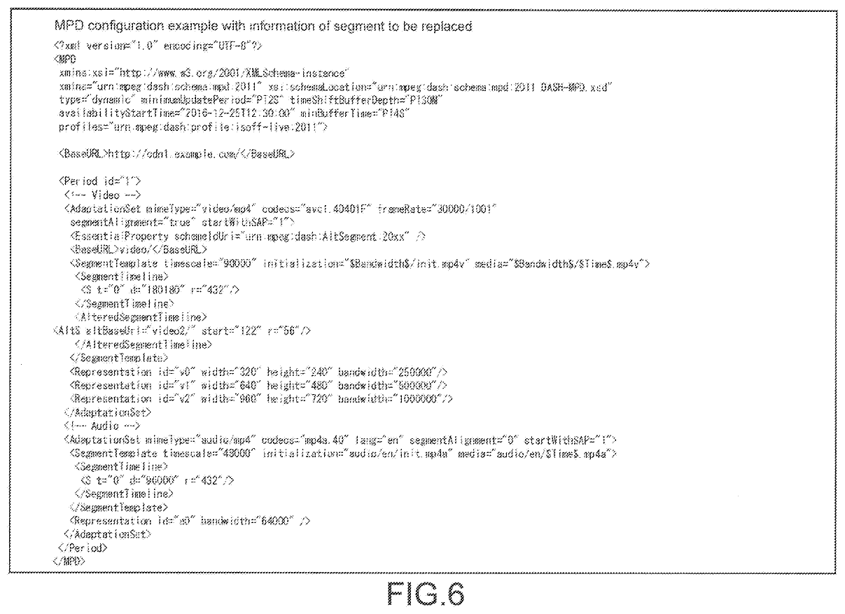

FIG. 5 shows an example of the MPD at live distribution. FIG. 6 shows an example of the MPD in which information of a segment to be replaced is added to MPD at live distribution.

As shown in FIG. 5, normally at live distribution, Segment Template is used, and Adaptation Set and Representation included therein are expressed by using Base URL, Segment Template, and Segment Timeline. Note that FIG. 5 shows an example of the video.

For example, a value of a timescale attribute of Segment Template is 90000, and a value of frameRate of Adaptation Set is 30000/1001=29.97 frame per second (fps). In the example shown in FIG. 5, duration specified in Segment Timeline is “180180”. Thus, each segment is 180180/90000=2.002 seconds, which is a time corresponding to 60 frames.

Here, a URL of each segment is obtained by connecting Base URL located immediately below Period and Base URL on the Adaptation Set level and further connecting the resulting URL and one obtained by replacing $Time$ of Segment Template with an elapsed time from the top calculated from the S element of Segment Timeline and replacing $Bandwidth$ with a bandwidth attribute value (character string) provided to each Representation. For example, the URL of the fifth segment of Representation of id=“v0” is http://cdn1.example.com/video/250000/720720.mp4v (720720=180180*4; the file name of the initial segment is “0.mp4v”.)

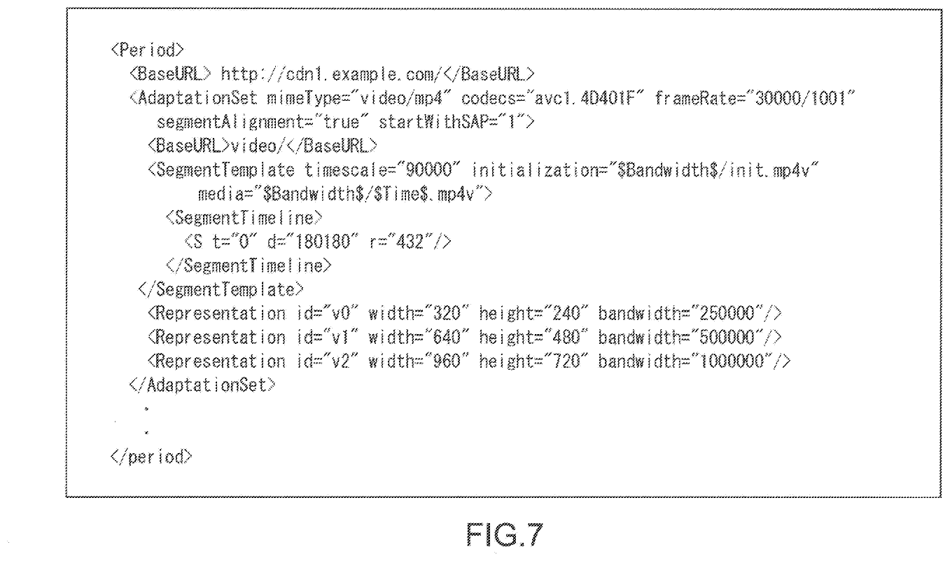

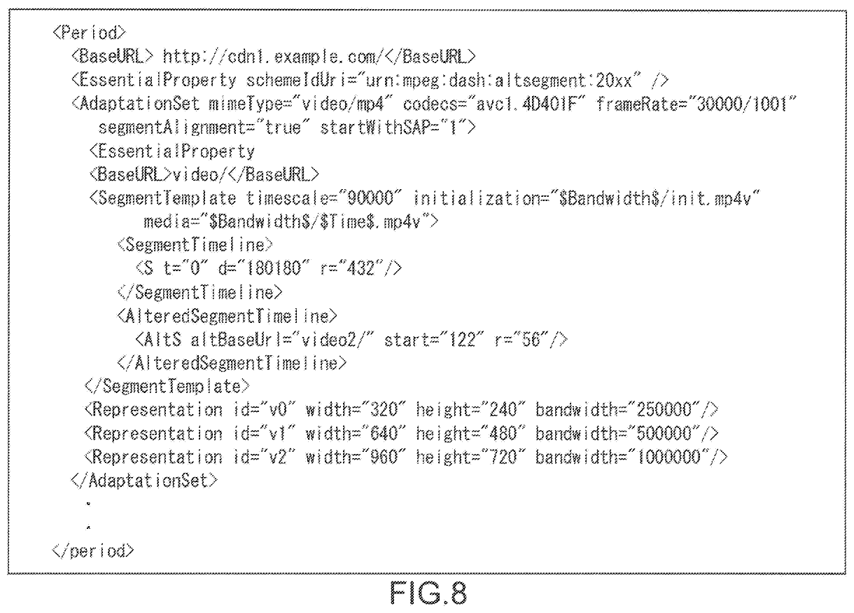

Here, information of a segment to be replaced is added. To do so, an Altered Segment Timeline element is defined as a slave element of a Segment Template element. Accordingly, the MPD of FIG. 7 can be expressed as shown in FIG. 8. This example applies to a case where 57 segments from the 123th segment to the 179th segment are replaced.

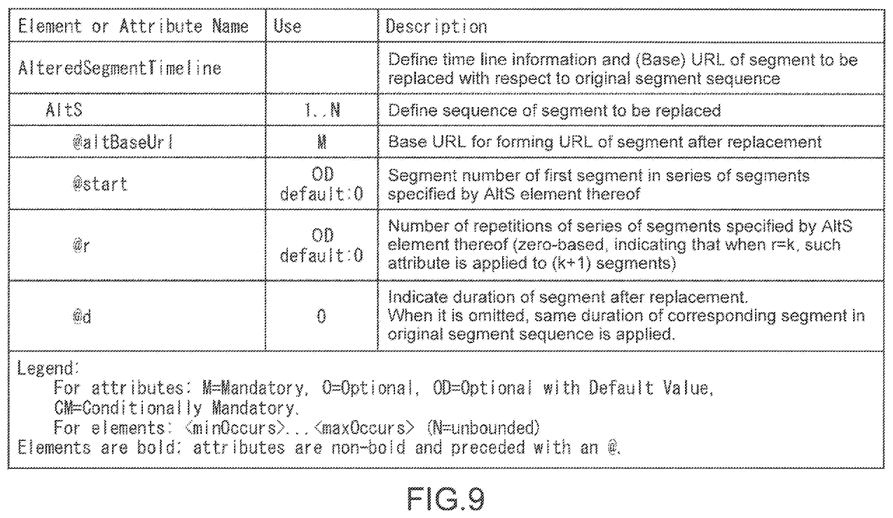

Further, the definition of the Altered Segment Timeline element is as shown in FIG. 9.

Accordingly, a client uses “video2/” as Base URL for URL generation (Adaptation Set level) for the 57 segments from the 123th segment to the 179th segment, acquires not segments originally prepared for live distribution but segments to be replaced, which are generated after offline editing, and reproduces them.

For example, the URL of the 123th segment, which is obtained after replacement, is calculated as 180180*122=21981960, and is thus http://cdn1.example.com/video2/250000/21981960.mp4v.

Note that, for the segments obtained after replacement, the length of each segment does not need to be the same as the length of the segment before replacement and can be set to be different between the segments. For example, it is assumed that, for encoding corresponding to the characteristics of the video, a picture-type interval called a stream access point (SAP, the top of the segment needs to be a SAP) is desired to be partially changed in DASH. Note that, also in such a case, the number of a series of segments to be replaced and the total length (duration) need to coincide with those before the replacement.

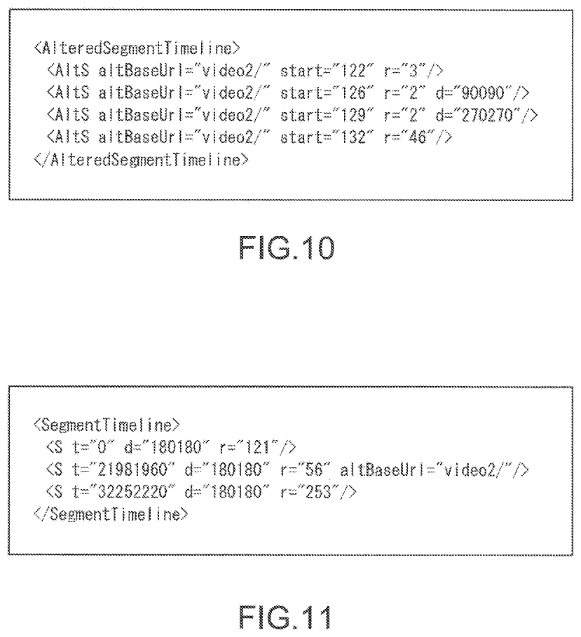

For example, as shown in FIG. 8, in a case where the 57 segments in total are replaced and in a case where an intermediate part needs a part in which SAP intervals are narrowed, duration of other segments have to be adjusted by a portion corresponding to one or a plurality of segments for which the intervals are narrowed. As a result, as shown in FIG. 10, a sequence of replacement segments is expressed by using a plurality of AltS elements.

In the example shown in FIG. 10, the 123th to 126th segments and the 132th to 179th segments have the same duration as that of the segments before the replacement, the 127th to 129th segments have the length adjusted to be half of the length before the replacement, and the 130th to the 132th segments have the length adjusted to be 1.5 times as long as the length before the replacement.

Note that, in a case where the original segments are deleted from the server after the replacement segments are provided, the stream can be correctly reproduced only when Altered Segment Timeline is correctly interpreted. Thus, in order to indicate that the Altered Segment Timeline element is used to express the above, an Essential Property Descriptor of schemeIdUri=“urn:mpeg:dash:altsegment:20xx” is added to the Adaptation Set level.

Further, if an @altBaseUrl attribute is additionally defined for an existing Segment Timeline element instead of newly defining the Altered Segment Timeline element, it is also possible to change Base URL given to Adaptation Set or Representation to one obtained after replacement, for some segments expressed by the Segment Timeline.

FIG. 11 shows an example of the Segment Timeline element in such a case. As shown in FIG. 11, “video2/” is applied as Base URL for URL generation (Adaptation Set level) for the 57 segments from the 123th segment to the 179th segment.

Next, description will be given on a method of transmitting information (MPD) of a segment, which is to be replaced with a segment created by offline editing, from the DASH distribution server to a CDN server by expansion of the following MPEG standard (SAND) (see, e.g., Non-Patent Literature 2).

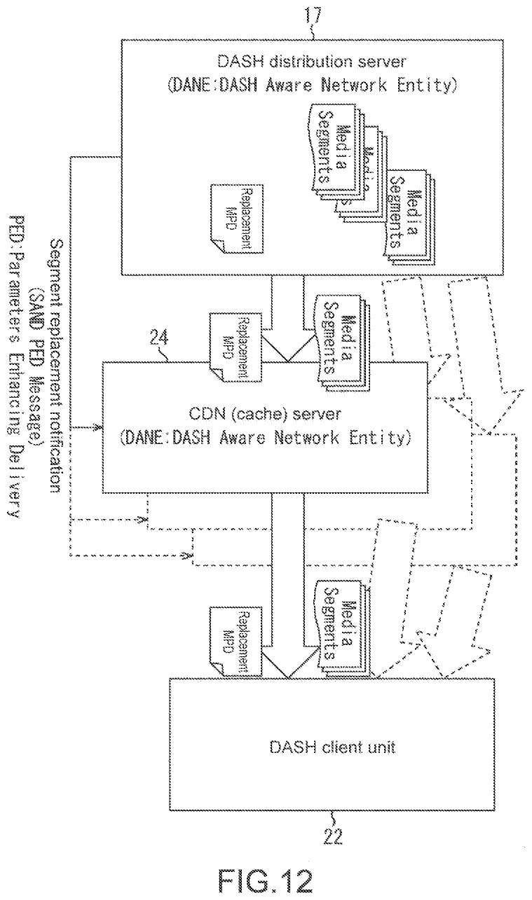

FIG. 12 is a block diagram showing a concept of transmitting an MPD and Media Segments to the DASH client unit 22 from the DASH distribution server 17 via the CDN (cache) server 24.

The MPEG-SAND standard is defined for the purpose of promoting efficiency of data distribution by the message exchange between the DASH distribution server 17 and the CDN server 24 or the DASH client unit 22. Of those, a message exchanged between the DASH distribution server 17 and the CDN server 24 is referred to as a parameter enhancing delivery (PED) message, and transmission of a segment replacement notification in this embodiment is one of the PED messages.

Note that, in the current situation, the PED message is merely mentioned in terms of the architecture in the MPEG standard, and a specific message is not defined. Further, the DASH distribution server 17 and the CDN server 24 that transmit and receive PED messages are each referred to as a DASH Aware Network Element (DANE) in the SAND standard.

For the exchange of SAND Messages between the DANEs, the following two methods are defined in the SAND standard.

The first method is a method of adding an expanded HTTP header with a URL for acquiring a SAND Message to, for example, a response to an HTTP GET request for accruing a Media Segment from a downstream DANE to an upstream DANE, transmitting the HTTP GET request to that URL by the downstream DANE that receives the response, and acquiring a SAND Message.

The second method is a method of establishing in advance a WebSocket channel for exchanging SAND messages between the DANEs and transmitting messages by using that channel.

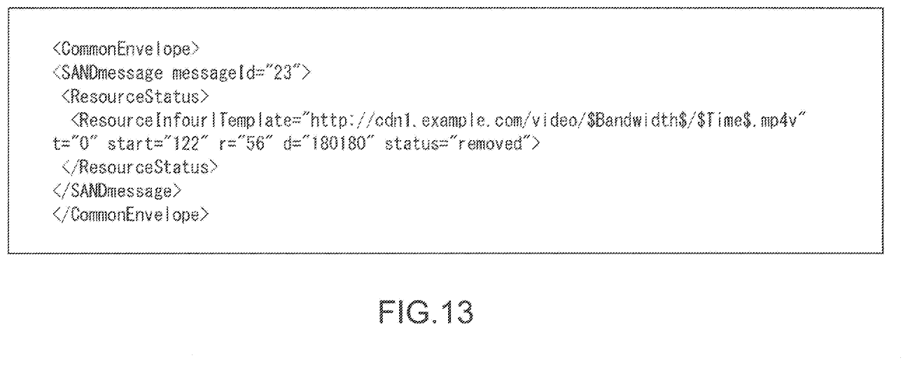

This embodiment can achieve an object thereof by using any of those two methods. However, since the first method is limited to a case where a message transmission destination transmits a request for acquiring a Media Segment, it is desirable to transmit messages by the second method. As a matter of course, even if messages are transmitted by the first method, an effect in a certain range can be obtained. Note that it is assumed that the SAND Message itself is described in an XML document in any case. Specifically, the SAND Message can be expressed as shown in FIG. 13.

Here, in <CommonEnvelope> shown in FIG. 13, a sender ID and generationTime can be added as attributes. For example, the value of messageId represents the type of a SAND Message. Here, it is a new message undefined in the standard and is assumed here as the value of “reserved for future ISO use”.

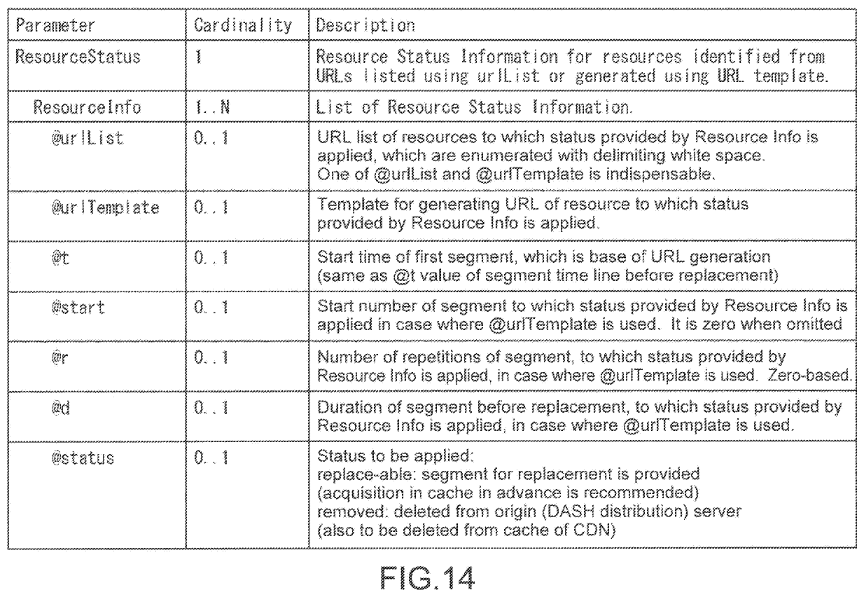

Further, a definition example of a ResourceStatus element is as shown in FIG. 14.

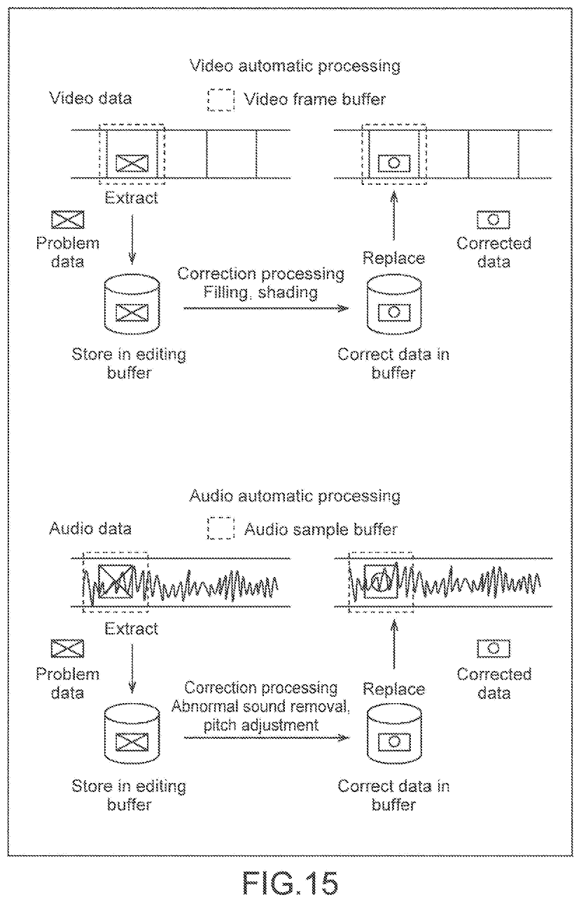

The video automatic processing and the audio automatic processing will be described with reference to FIG. 15.

For example, in the video online editing unit 14, RAW data obtained after the imaging apparatuses 12-1 to 12-3 capture images can be corrected by the video automatic processing unit 31. Similarly, in the audio online editing unit 15, PCM data obtained after the sound collection apparatuses 13-1 to 13-3 collect sounds can be corrected by the audio automatic processing unit 32.

The video automatic processing unit 31 temporarily stores the video data in the video frame buffer and detects whether or not the video data in the frame buffer has a problem part, for example, abnormal video noise at imaging or an unacceptable scene or the like considered to be unacceptable by a video director. Then, if the video data has a problem part, the video automatic processing unit 31 corrects the video data in the problem part by filling or shading. Subsequently, the video automatic processing unit 31 replaces the problem data with the corrected data to overwrite the data. Further, the video automatic processing unit 31 can perform such processing within a time in the range of distribution delay.

The audio automatic processing unit 32 temporarily stores the audio data in the audio sample buffer and detects whether or not the audio data in the audio sample buffer has a problem part, for example, an abnormal sound or an off-pitch part. Then, if the audio data has a problem part, the audio automatic processing unit 32 corrects the audio data in the problem part by removing an abnormal sound or adjusting the pitch. Subsequently, the audio automatic processing unit 32 replaces the problem data with the corrected data to overwrite the data. Further, the audio automatic processing unit 32 can perform such processing within a time in the range of distribution delay.

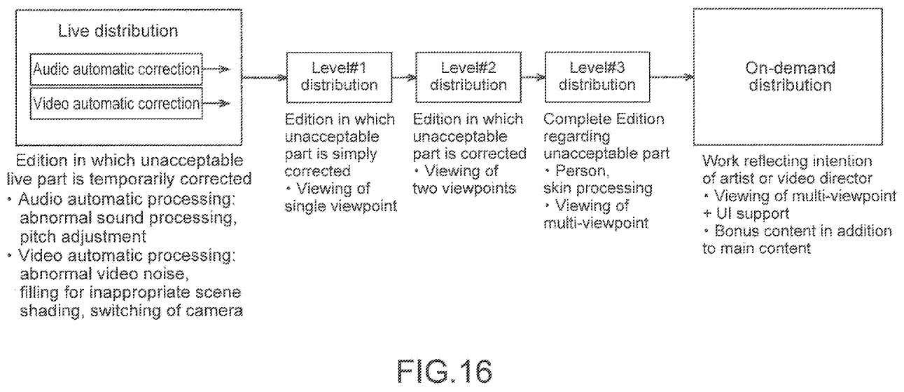

An editing level will be described with reference to FIG. 16.

First, in the live distribution, the video automatic processing unit 31 and the audio automatic processing unit 32 perform automatic correction as described with reference to FIG. 15, and an unacceptable live part is temporarily corrected.

For example, also in the live distribution, data processing reflecting the intention of an artist or a content provider is enabled. Then, after the live distribution, the content is stepwisely updated and eventually leads to the video on-demand distribution. Accordingly, a viewer can view the content updated at that point in time by streaming, as needed, without time intervals.

The stepwise content updating allows the quality of the content to be enhanced and the function to be expanded. The viewer can view more sophisticated content. For example, the viewer can enjoy various angles from a single viewpoint to a multi-viewpoint. The stepwise content updating allows a stepwise charging model to be established.

In other words, the content value is increased in the order of the live distribution, the distribution of level 1 to level 3, and the on-demand distribution, and thus pricing appropriate to each distribution can be performed.

Here, in the live distribution, the distribution content including automatic correction is defined as an “edition in which an unacceptable part considered to be inappropriate by an artist or a video director is temporarily corrected”. The video automatic processing corresponds to “filling” or “shading” of an inappropriate video, and camera video switching can be performed. The audio automatic processing can perform processing for an abnormal sound from a microphone or deal with an off-pitch part. Further, a time for those types of processing is approximately several seconds, and a distribution target is a person who applies for and registers live viewing.

Further, in the distribution of level 1, the distribution content is defined as an “edition in which unacceptable live part is simply corrected” and is, for example, a service limited to participants of a live performance or viewers. The video/audio processing is simple correction of only an unacceptable part for an artist or a video director. It is assumed that the number of viewpoints for viewing is a single viewpoint and that the distribution target is people who participated in the live performance and wants to view it immediately again or who viewed the live distribution. Further, a distribution period can be set to several days after the live performance.

Further, in the distribution of level 2, the distribution content is defined as an “edition in which an unacceptable part is corrected, and which corresponds to two viewpoints”. For example, it is assumed that on-demand content is elaborated from here. The video/audio processing is for an edition in which an unacceptable part for an artist or a video director is corrected. The number of viewpoints for viewing is two, and the user can select an angle. Further, the distribution target is people who are fans of the artist and want to enjoy the live performance. Further, a distribution period can be set to two weeks after the live performance.

Further, in the distribution of level 3, the distribution content is defined as a “complete edition regarding an unacceptable part, which corresponds to a multi-viewpoint”. In other words, it is before the final elaboration. The video/audio processing is complete correction of an unacceptable part for an artist or a video director, and processing for person and skin. The number of viewpoints for viewing is three, and the user can select an angle. Further, the distribution target is people who are fans of the artist and want to enjoy the live performance or who want to view it earlier than the on-demand distribution. Further, a distribution period can be set to four weeks after the live performance.

Further, in the on-demand distribution, the distribution content is defined as a “final product reflecting the intension of an artist or a video director”. In other words, it is the final edition of the elaboration. The video/audio processing is performed on the full-length videos and sounds. In addition to main content, bonus content is also provided. The number of viewpoints for viewing is multiple, favorably three or more, and the user can select an angle by using a user interface. Further, the distribution target is people who are fans of the artist and also who are general music funs and want to enjoy a live performance as a work. The distribution period can be set to several months after the live performance.

FIG. 17 is a block diagram showing a configuration example of the DASH client unit 22.

As shown in FIG. 17, the DASH client unit 22 includes a data storage 41, a DEMUX unit 42, a video decoding unit 43, an audio decoding unit 44, a video reproduction unit 45, and an audio reproduction unit 46. Then, the DASH client unit 22 can receive segment data and MPD data from the DASH distribution server 17 via the network 23 of FIG. 1.

The data storage 41 temporarily holds the segment data and the MPD data that are received by the DASH client unit 22 from the DASH distribution server 17.

The DEMUX unit 42 separates the segment data read from the data storage 41 so as to decode the segment data, and supplies video data to the video decoding unit 43 and audio data to the audio decoding unit 44.

The video decoding unit 43 decodes the video data and supplies the resultant data to the video reproduction unit 45. The audio decoding unit 44 decodes the audio data and supplies the resultant data to the audio reproduction unit 46.

The video reproduction unit 45 is, for example, a display and reproduces and displays the decoded video. The audio reproduction unit 46 is, for example, a speaker and reproduces and outputs the decoded sound.

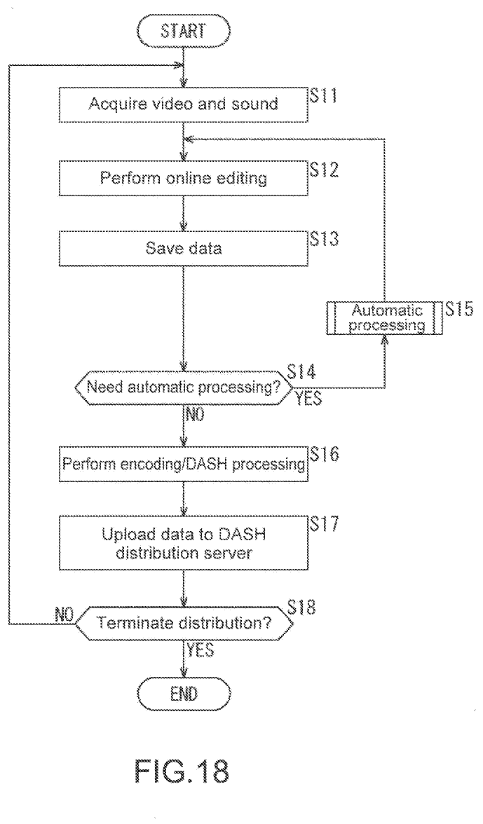

FIG. 18 is a flowchart for describing live distribution processing executed by the content distribution system 11.

In Step S11, the video online editing unit 14 acquires a video captured by the imaging apparatus 12, and the audio online editing unit 15 acquires a sound collected by the sound collection apparatus 13.

In Step S12, the video online editing unit 14 performs online editing on the video, and the audio online editing unit 15 performs online editing on the sound.

In Step S13, the video online editing unit 14 supplies the video, which has been subjected to the online editing, to the video saving unit 18 and saves it. The audio online editing unit 15 supplies the sound, which has been subjected to the online editing, to the audio saving unit 20 and saves it.

In Step S14, the video automatic processing unit 31 and the audio automatic processing unit 32 determine whether the automatic processing is necessary to perform or not.

In Step S14, if the video automatic processing unit 31 and the audio automatic processing unit 32 determine that the automatic processing is necessary to perform, the processing proceeds to Step S15, and the automatic processing is performed. Then, after the automatic processing is performed, the processing returns to Step S12, and similar processing is repeated thereafter.

Meanwhile, in Step S14, if the video automatic processing unit 31 and the audio automatic processing unit 32 determine that the automatic processing is unnecessary to perform, the processing proceeds to Step S16. In Step S16, the encoding/DASH processing unit 16 encodes video and sound streams, generates DASH data, and performs ISOBMFF segmentalization for each of the segments.

In Step S17, the encoding/DASH processing unit 16 uploads the DASH data, which has been subjected to ISOBMFF segmentalization for each of the segments in Step S16, to the DASH distribution server 17.

In Step S18, it is determined whether the distribution is terminated or not. If it is determined that the distribution is not terminated, the processing returns to Step S11, and similar processing is repeated thereafter. Meanwhile, in Step S18, if it is determined that the distribution is terminated, the live distribution processing is terminated.

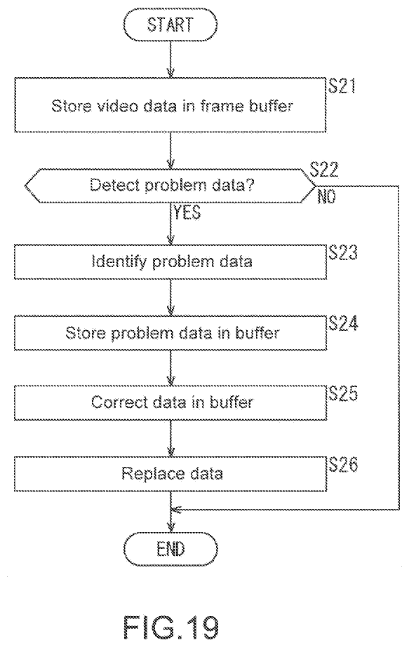

FIG. 19 is a flowchart for describing the video automatic processing executed in Step S15 of FIG. 18.

In Step S21, the video automatic processing unit 31 stores the video data in the frame buffer. For example, a video signal captured in real time by the imaging apparatus 12 is stored in the buffer in a group of the video frames via the VE.

In Step S22, the video automatic processing unit 31 determines whether problem data is detected or not. For example, the video automatic processing unit 31 refers to the video data within the frame buffer and detects whether the video data includes abnormal video noise or an inappropriate scene. Then, in Step S22, if it is determined that problem data is detected, the processing proceeds to Step S23.

In Step S23, the video automatic processing unit 31 identifies the problem data. For example, the video automatic processing unit 31 identifies a video area or a target pixel or section in the problem part.

In Step S24, the video automatic processing unit 31 stores the problem data in the buffer. In Step S25, the video automatic processing unit 31 corrects the data within the buffer. For example, correction such as filling or shading of the problem video area is performed.

In Step S26, the video automatic processing unit 31 overwrites the original data having the problem with the corrected data corrected in Step S25 to replace the data. The video automatic processing is then terminated.

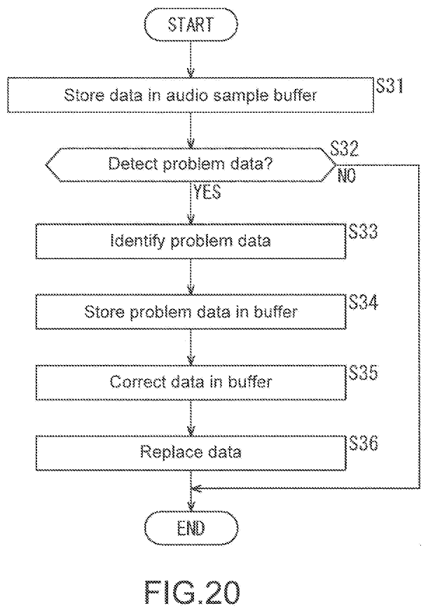

FIG. 20 is a flowchart for describing audio automatic processing executed in Step S15 of FIG. 18.

In Step S31, the audio automatic processing unit 32 stores the audio data in the audio sample buffer. For example, a PCM audio collected in real time by the sound collection apparatus 13 is stored in the buffer in a group of the audio samples via the PA.

In Step S32, the audio automatic processing unit 32 determines whether problem data is detected or not. For example, the audio automatic processing unit 32 checks waveforms of the audio data within the audio sample buffer and detects an abnormal sound or an off-pitch part. Then, in Step S32, if it is determined that problem data is detected, the processing proceeds to Step S33.

In Step S33, the audio automatic processing unit 32 identifies the problem data. For example, the audio automatic processing unit 32 identifies an audio sample section of the problem part.

In Step S34, the audio automatic processing unit 32 stores the problem data in the buffer, and in Step S35, corrects the data within the buffer. For example, correction such as filling or shading of the problem video area is performed.

In Step S36, the audio automatic processing unit 32 overwrites the original data having the problem with the corrected data corrected in Step S35 to replace the data. The audio automatic processing is then terminated.

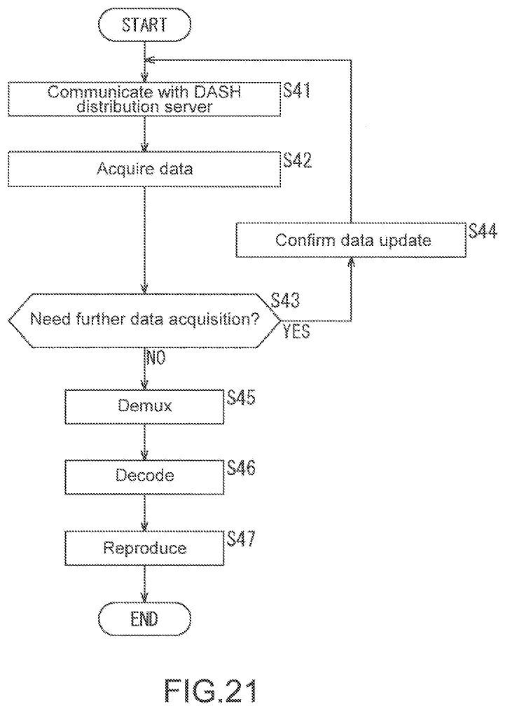

FIG. 21 is a flowchart for describing DASH client processing that is executed by the DASH client unit 22 of FIG. 17.

In Step S41, the DASH client unit 22 performs HTTP communication with the DASH distribution server 17 via the network 23 of FIG. 1.

In Step S42, the DASH client unit 22 acquires the segment data and the MPD data from the DASH distribution server 17 and causes the data storage 41 to temporarily hold the data.

In Step S43, the DASH client unit 22 determines whether further data acquisition is necessary to perform or not. Then, if the DASH client unit 22 determines that further data acquisition is necessary to perform, the processing proceeds to Step S44. The DASH client unit 22 confirms the data update with respect to the DASH distribution server 17, and the processing returns to Step S41.

Meanwhile, in Step S43, if the DASH client unit 22 determines that further data acquisition is unnecessary to perform, the processing proceeds to Step S45.

In Step S45, the DEMUX unit 42 demuxes the segment data read from the data storage 41, supplies the video data to the video decoding unit 43, and supplies the audio data to the audio decoding unit 44.

In Step S46, the video decoding unit 43 decodes the video data, and the audio decoding unit 44 decodes the audio data.

In Step S47, the video reproduction unit 45 reproduces the video decoded by the video decoding unit 43, and audio reproduction unit 46 reproduces the sound decoded by the audio decoding unit 44. Subsequently, the DASH client processing is terminated.

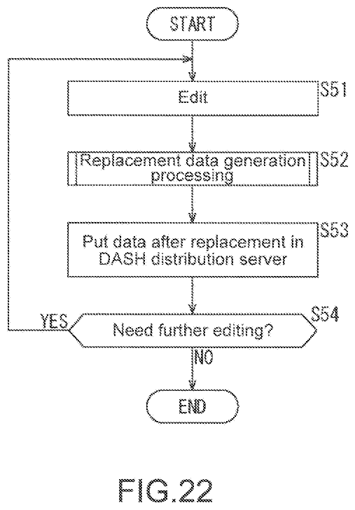

FIG. 22 is a flowchart for describing offline editing processing.

In Step S51, the video offline editing unit 19 reads the stream for live distribution saved in the video saving unit 18 and edits the stream.

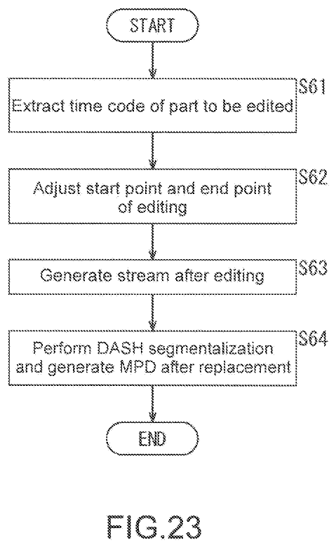

In Step S52, the video offline editing unit 19 performs replacement data generation processing (FIG. 23) of generating a replacement segment corresponding to a data structure at the live distribution.

In Step S53, the video offline editing unit 19 generates an MPD reflecting the replacement and disposes the MPD together with the replacement segment in the DASH distribution server 17.

In Step S54, it is determined whether further editing is necessary to perform or not. If it is determined that further editing is necessary to perform, the processing returns to Step S51, and similar processing is repeated. Meanwhile, if it is determined that further editing is unnecessary to perform, the offline editing processing is terminated.

FIG. 23 is a flowchart for describing the replacement data generation processing executed in Step S52 of FIG. 22.

In Step S61, the video offline editing unit 19 and the audio offline editing unit 21 extract a time code of a part to be edited from the video and sound in the live distribution stream.

In Step S62, the video offline editing unit 19 and the audio offline editing unit 21 adjusts the start point and the end point of editing so as to coincide with the boundary of segments by using the segment time code information saved when the DASH data of the live distribution stream is generated.

In Step S63, the video offline editing unit 19 and the audio offline editing unit 21 creates an edited stream corresponding to segments to be replaced from the saved original data and supplies the edited stream to the encoding/DASH processing unit 16.

In Step S64, the encoding/DASH processing unit 16 performs DASH segmentalization on the edited stream and also generates MPD after replacement.

Subsequently, the replacement data generation processing is terminated, and the processing proceeds to Step S53 of FIG. 22. The segment for replacement generated in Step S64 and the MPD to which the replacement is applied are uploaded to the DASH distribution server 17.

As described above, the content distribution system 11 of this embodiment allows data to be replaced in units of segment and the video and sound to be edited. Then, if the replacement is performed in units of one or a plurality of continuous DASH media segments, not only the data on the distribution server but also the data cached by the content delivery network (CDN) can be efficiently replaced while using useable data out of the data at the live distribution as it is, and segment data to be acquired can be reported to a streaming reproduction client.

Accordingly, the content distribution system 11 can dispose, in the distribution server, only segment data to be substituted by post-editing out of the live distribution data and can replace the data at live distribution with the segment data. Further, the content distribution system 11 can add information regarding an URL obtained after the replacement to only the segments with which the MPD used at live distribution is replaced, and can reuse the segments of the data at live distribution, which are usable as they are. Additionally, when the segments on the DASH distribution server 17 are replaced, the content distribution system 11 can notify the CDN server 24 of such replacement information as update information.

Note that the processes described with reference to the respective flowcharts described above are not necessarily performed in chronological order along the order described as the flowcharts and include processes to be executed in parallel or individually (e.g., parallel processing or processing by object). Further, a program may be processed by a single CPU or may be distributed and processed by a plurality of CPUs.

Further, a series of processes described above (content processing method) can be executed by hardware or software. In a case where the series of processes is executed by software, a program constituting the software is installed in a computer from a program recording medium recording programs, the computer including a computer incorporated in dedicated hardware or, for example, a general-purpose personal computer that can execute various functions by installing various programs therein.

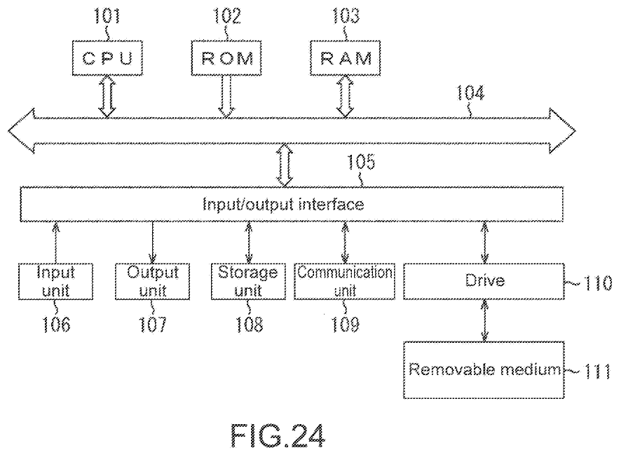

FIG. 24 is a block diagram showing a configuration example of hardware of the computer that executes the series of processes described above by a program.

In the computer, a central processing unit (CPU) 101, a read only memory (ROM) 102, a random access memory (RAM) 103 are connected to one another by a bus 104.

Additionally, an input/output interface 105 is connected to the bus 104. An input unit 106 including a keyboard, a mouse, a microphone, and the like, an output unit 107 including a display, a speaker, and the like, a storage unit 108 including a hard disk, a nonvolatile memory, and the like, a communication unit 109 including a network interface and the like, and a drive 110 that drives a removable medium 111 such as a magnetic disk, an optical disc, a magneto-optical disk, or a semiconductor memory are connected to the input/output interface 105.

In the computer configured as described above, the CPU 101 loads the program stored in, for example, the storage unit 108 to the RAM 103 via the input/output interface 105 and the bus 104 and executes the program, to perform the series of processes described above.

The program executed by the computer (CPU 101) can be provided by, for example, being recorded on the removable medium 111 as a package medium including a magnetic disk (including a flexible disk), an optical disc (CD-ROM (Compact Disc-Read Only Memory), a DVD (Digital Versatile Disc), or the like), a magneto-optical disk, a semiconductor memory, or the like. Alternatively, the program can be provided via a wireless or wired transmission medium such as a local area network, the Internet, or digital satellite broadcasting.

Then, by mounting of the removable medium 111 to the drive 110, the program can be installed in the storage unit 108 via the input/output interface 105. Further, the program can be received by the communication unit 109 via the wireless or wired transmission medium and installed in the storage unit 108. In addition, the program can be installed in advance in the ROM 102 or the storage unit 108.

<Combination Example of Configurations>

Note that the present technology can have the following configurations.

(1) A content processing apparatus, including

an online editing unit that
stores content data for live distribution in an editing buffer,
corrects, if the content data includes a problem part, the content data within the editing buffer,
replaces the content data with the corrected content data, and
distributes the corrected content data.
   (2) The content processing apparatus according to (1), further including:

a saving unit that saves the content data corrected by the online editing unit; and

an offline editing unit that
reads the content data from the saving unit, and
edits the content data on a plurality of editing levels.
   (3) The content processing apparatus according to (2), further including

an encoding processing unit that
encodes the content data for each predetermined segment, and
generates control information used for controlling content distribution, wherein

the encoding processing unit replaces the content data with the content data edited by the online editing unit or the content data edited by the offline editing unit in units of the segment by rewriting the control information.
(4) The content processing apparatus according to (3), in which the offline editing unit stepwisely edits each part of the content data, and edits the content data on a higher editing level in accordance with lapse of time after live distribution of the content data.
   (5) The content processing apparatus according to (4), in which

the encoding processing unit sequentially replaces, when the offline editing unit edits the content data, each segment with the edited part.

(6) The content processing apparatus according to any one of (3) to (5), in which

the control information is used for replacement with the content data edited by the offline editing unit for each segment and is transmitted from a dynamic adaptive streaming over HTTP (DASH) distribution server to a content delivery network (CDN) server by expansion of a server and network assisted DASH (SAND).

(7) The content processing apparatus according to (6), in which

the CDN server is notified of replacement information of the part edited by the offline editing unit, the replacement information being included in the content data disposed in the CDN server.

(8) A content processing method, including the steps of:

storing content data for live distribution in an editing buffer;

correcting, if the content data includes a problem part, the content data within the editing buffer;

replacing the content data with the corrected content data; and

distributing the corrected content data.

(9) A program that causes a computer to execute content processing including the steps of:

storing content data for live distribution in an editing buffer;

correcting, if the content data includes a problem part, the content data within the editing buffer;

replacing the content data with the corrected content data; and

distributing the corrected content data.

Note that this embodiment is not limited to the embodiment described above and can be variously modified without departing from the gist of the present disclosure.

### REFERENCE SIGNS LIST

11 content distribution system
12 imaging apparatus
13 sound collection apparatus
14 video online editing unit
15 audio online editing unit
16 encoding/DASH processing unit
17 DASH distribution server
18 video saving unit
19 video offline editing unit
20 audio saving unit
21 audio offline editing unit
22 DASH client unit
23 network
31 video automatic processing unit
32 audio automatic processing unit
33 segment management unit

1-9. (canceled)

10. A content processing apparatus, comprising
an encoding processing unit that
generates a plurality of distribution segments that are encoded at a plurality of bit rates on a basis of stream data for live distribution,
generates control information that controls access information for each of the generated distribution segments,
rewrites access information of the control information for a first distribution segment with access information for a second distribution segment different from the first distribution segment, and
transfers the distribution segment and the control information to a distribution server.

11. The content processing apparatus according to claim 10, wherein if the first distribution segment has a problem, the encoding processing unit
selects, from the plurality of distribution segments different from the first distribution segment, a normal segment as the second distribution segment, and
rewrites the access information of the control information.

12. The content processing apparatus according to claim 11, wherein
the encoding processing unit includes a segment management unit that manages the generated segments, and
the segment management unit monitors presence of a lack of data in the first distribution segment.

13. The content processing apparatus according to claim 12, wherein
the second distribution segment is a normal segment different from the first distribution segment in bit rate.

14. The content processing apparatus according to claim 10, further comprising:
a saving unit that saves the stream data for live distribution and original stream data for live distribution; and
an offline editing unit that reads the stream data from the saving unit and edits the stream data on a plurality of editing levels, wherein
the encoding processing unit
encodes stream data for replacement regarding an edited part generated by the offline editing unit, and
generates segment data as the second distribution segment.

15. The content processing apparatus according to claim 14, wherein the offline editing unit
stepwisely edits each part of the content data, and
edits the content data on a higher editing level in accordance with lapse of time after live distribution of the content data.

16. The content processing apparatus according to claim 14, wherein
the control information is used for replacement with the content data edited by the offline editing unit for each of the segments and is transmitted from a dynamic adaptive streaming over HTTP (DASH) distribution server to a content delivery network (CDN) server by expansion of a server and network assisted DASH (SAND).

17. The content processing apparatus according to claim 16, wherein
the CDN server is notified of replacement information of the part edited by the offline editing unit, the replacement information being included in the content data disposed in the CDN server.

18. The content processing apparatus according to claim 10, further comprising
an online editing unit that
stores original stream data for live distribution in a buffer for editing, and
edits the original stream data for live distribution, wherein the online editing unit
corrects, if the original stream data for live distribution in the in a buffer has a problem, the content data within the buffer for editing, and
outputs the corrected content data as the stream data for live distribution to the encoding processing unit.

19. A content processing method, comprising the steps of:
generating a plurality of distribution segments that are encoded at a plurality of bit rates on a basis of stream data for live distribution;
generating control information that controls access information for each of the generated distribution segments;
rewriting access information of the control information for a first distribution segment with access information for a second distribution segment different from the first distribution segment; and
transferring the distribution segment and the control information to a distribution server.

20. A program that causes a computer to execute content processing including the steps of:
generating a plurality of distribution segments that are encoded at a plurality of bit rates on a basis of stream data for live distribution;
generating control information that controls access information for each of the generated distribution segments;
rewriting access information of the control information for a first distribution segment with access information for a second distribution segment different from the first distribution segment; and
transferring the distribution segment and the control information to a distribution server.
